(19) United States
(12) Patent Application Publication
(10) Pub. No.: US 2018/0211104 A1
(43) Pub. Date: Jul. 26, 2018

(54) METHOD AND DEVICE FOR TARGET TRACKING

(71) Applicant: ZHEJIANG SHENGHUI LIGHTING CO., LTD, Jiaxing (CN)

(72) Inventors: Yanguo ZHAO, Jiaxing (CN); Jinxiang SHEN, Jiaxing (CN)

(21) Appl. No.: 15/743,994

(22) PCT Filed: Feb. 28, 2017
(86) PCT No.: PCT/CN2017/075104

§ 371 Date: Jan. 11, 2018

(30) Foreign Application Priority Data
Mar. 10, 2016 (CN) 201610137587.X

(51) Int. Cl. G06K 9/00; G06T 7/246; G06K 9/32; G06K 9/62

(52) U.S. Cl. CPC G06K 9/00355; G06T 7/251; G06T 2207/30196; G06K 9/6215; G06T 2207/20076; G06K 9/3233

(57) ABSTRACT

The present disclosure provides a method and a device for target tracking. The method includes: obtaining a primary forecasting model and a verification model of a target, the primary forecasting model containing low-level features of the target and the verification model containing high-level features of the target; obtaining a current frame of a video image and determining a tracking region of interest (ROI) and a motion-confining region in the current frame based on a latest status of the target, wherein the tracking ROI moves in accordance to a movement of the target; forecasting a status of the target in the current frame in the tracking ROI based on the primary forecasting model; and determining a target image containing the target based on the status of the target in the current frame. The method further includes extracting high-level features of the target from the target image.

### CROSS-REFERENCES TO RELATED APPLICATIONS

This application claims the priority of Chinese Patent Application No. 201610137587.X filed on Mar. 10, 2016, the entire content of which is incorporated herein by reference.

### FIELD OF THE DISCLOSURE

The present disclosure relates to the field of tracking technologies and, more specially, relates to a method and a device for target tracking.

### BACKGROUND

Video surveillance is the physical base for real-time monitoring of important places such as enterprises, commercial sites, and parks. The management department can obtain useful data, images and/or audio information from the video surveillance. With the rapid development and popularization of computer applications, the principles of video surveillance have been widely applied to the single-target-gesture tracking systems. A single-target-gesture tracking system can track and recognize a user's target gesture, and implement certain control functions according to the gesture.

However, during the tracking of a gesture through a conventional single-target-gesture tracking system, tracking loss and/or tracking drift due to the interference by a target similar to a human's hand occur when the hand gesture changes. Therefore, a conventional single-target-gesture tracking system has low tracking efficiency and poor robustness.

The disclosed device and method are directed to solve one or more problems set forth above and other problems.

### BRIEF SUMMARY OF THE DISCLOSURE

One aspect or embodiment of the present disclosure includes a method for target tracking, including: obtaining a primary forecasting model and a verification model of a target, the primary forecasting model containing low-level features of the target and the verification model containing high-level features of the target; obtaining a current frame of a video image and determining a tracking region of interest (ROI) and a motion-confining region in the current frame based on a latest status of the target, wherein the tracking ROI moves in accordance to a movement of the target; forecasting a status of the target in the current frame in the tracking ROI based on the primary forecasting model; determining a target image containing the target based on the status of the target in the current frame; and extracting high-level features of the target from the target image, determining whether a matching level between extracted high-level features and the verification model is greater than or equal to a predetermined similarity threshold value, and determining a current position of the target in the target image is within the motion-confining region. The method may further include: when the matching level between extracted high-level features and the verification model is greater than or equal to a predetermined similarity threshold value and the current position of the target in the target image is within the motion-confining region, determining the target tracking is successful.

Optionally, the method further includes: determining whether predefined targets other than the target is detected in the tracking ROI and obtaining a detection result; and determining whether a reinitialization of the primary forecasting model and the verification model is needed based on the detection result.

Optionally, obtaining a primary forecasting model and a verification model of a target includes: applying a first descriptive method to extract the low-level features of the target and applying a second descriptive method to extract the high-level features of the target; and extracting high-level features of the target from the target image includes applying the second descriptive method to extract the high-level features of the target. A complexity level of the first descriptive method is lower than a complexity level of the second descriptive method.

Optionally, determining whether a reinitialization of the primary forecasting model and the verification model is needed based on the detection result includes: when the detection result indicates predefined targets other than the target exist in the tracking ROI, reinitializing the primary forecasting model and the verification model based on the predefined targets; and when the detection result indicates no predefined targets other than the target exists in the tracking ROI and the target tracking in the current frame was successful, performing parameter correction on the primary forecasting model and the verification model.

Optionally, the method further includes displaying a tracking status of the target in the current frame and the detection result.

Optionally, the method further includes: determining whether a user action has been detected, the user action being a predetermined action; and when the user action has been detected, terminating the target tracking.

Optionally, the matching level between extracted high-level features and the verification model is greater than or equal to a predetermined similarity threshold value, and the current position of the target in the target image is outside the motion-confining region, further includes: step A, determining a tracking ROI of the target in a next frame based on the latest status of the target; step B, determining whether the target tracking is successful in the next frame based on the tracking ROI in the next frame, the primary forecasting model, and the verification model; and step C, when it is determined the target tracking is unsuccessful, returning to step A.

Optionally, when the target tracking succeeds before a total number of unsuccessful target tracking reaches a predetermined number, determining the target to be temporarily lost; and when the total number of unsuccessful target tracking reaches the predetermined number, determining the target to be permanently lost and terminating the target tracking.

Optionally, the target is a gesture.

Another aspect of the present disclosure provides a device for target tracking, including: a first obtaining module for obtaining a primary forecasting model and a verification model of a target, the primary forecasting model containing low-level features of the target and the verification model containing high-level features of the target; a second obtaining module for obtaining a current frame of a video image and determining a tracking region of interest (ROI) and a motion-confining region in the current frame based on a latest status of the target, wherein the tracking ROI moves in accordance to a movement of the target; and a forecasting module for forecasting a status of the target in the current frame in the tracking ROI based on the primary forecasting model. The device also includes a verifying module for determining a target image containing the target based on the status of the target in the current frame, extracting high-level features of the target from the target image, determining whether a matching level between extracted high-level features and the verification model is greater than or equal to a predetermined similarity threshold value, and determining a current position of the target in the target image is within the motion-confining region; and a first determining module, when the matching level between extracted high-level features and the verification model is greater than or equal to a predetermined similarity threshold value and the current position of the target in the target image is within the motion-confining region, for determining the target tracking was successful.

Optionally, the device further includes: a detecting module for determining whether predefined targets other than the target is detected in the tracking ROI and obtaining a detection result; and a processing module for determining whether a reinitialization of the primary forecasting model and the verification model is needed based on the detection result.

Optionally, obtaining a primary forecasting model and a verification model of a target includes: applying a first descriptive method to extract the low-level features of the target and applying a second descriptive method to extract the high-level features of the target; and extracting high-level features of the target from the target image includes applying the second descriptive method to extract the high-level features of the target. A complexity level of the first descriptive method is lower than a complexity level of the second descriptive method.

Optionally, the processing module includes: a first processing unit, when the detection result indicates predefined targets other than the target exist in the tracking ROI, for reinitializing the primary forecasting model and the verification model based on the predefined targets; a second processing unit, when the detection result indicates no predefined targets other than the target exists in the tracking ROI and the target tracking in the current frame was unsuccessful, for cancelling reinitializing the primary forecasting model and the verification model based on the predefined targets; and a third processing unit, when the detection result indicates no predefined targets other than the target exists in the tracking ROI and the target tracking in the current frame was successful, for performing parameter correction on the primary forecasting model and the verification model.

Optionally, the device further includes a display module for displaying a tracking status of the target in the current frame and the detection result.

Optionally, the device further includes a second determining module for determining whether a user action has been detected, the user action being a predetermined action; and when the user action has been detected, stop the target tracking.

Optionally, when the matching level between extracted high-level features and the verification model is greater than or equal to a predetermined similarity threshold value, and the current position of the target in the target image is outside the motion-confining region, the second obtaining module determines a tracking ROI of the target in a next frame based on the latest status of the target; and the first determining module determines whether the target tracking is successful in the next frame based on the tracking ROI in the next frame, the primary forecasting model, and the verification model, and when it is determined the target tracking is unsuccessful, and returns to determining a tracking ROI of the target in a next frame based on the latest status of the target to determine whether the target tracking is successful in the next frame.

Optionally, the first determining module determines the target to be temporarily lost when the target tracking succeeds before a total number of unsuccessful target tracking reaches a predetermined number; and determines the target to be permanently lost and stopping the target tracking when the total number of unsuccessful target tracking reaches the predetermined number.

### BRIEF DESCRIPTION OF THE DRAWINGS

The following drawings are merely examples for illustrative purposes according to various disclosed embodiments and are not intended to limit the scope of the present disclosure.

FIG. 1 illustrates an exemplary process of target tracking consistent with various disclosed embodiments of the present disclosure;

FIG. 2 illustrates another exemplary process of target tracking consistent with various disclosed embodiments of the present disclosure;

FIG. 3 illustrates another exemplary process of target tracking consistent with various disclosed embodiments of the present disclosure;

FIG. 4 illustrates an exemplary tracking region of interest (ROI) and an exemplary motion-confining region consistent with various disclosed embodiments of the present disclosure;

FIG. 5 illustrates another exemplary process of target tracking consistent with various disclosed embodiments of the present disclosure;

FIG. 6 illustrates an exemplary detection of repeatedly waving gesture consistent with various disclosed embodiments of the present disclosure;

FIG. 7 illustrates an exemplary device for target tracking consistent with various disclosed embodiments of the present disclosure;

FIG. 8 illustrates another exemplary device for target tracking consistent with various disclosed embodiments of the present disclosure; and

FIG. 9 illustrates another exemplary device for target tracking consistent with various disclosed embodiments of the present disclosure;

### DETAILED DESCRIPTION

Reference will now be made in detail to exemplary embodiments of the invention, which are illustrated in the accompanying drawings. Hereinafter, embodiments consistent with the disclosure will be described with reference to drawings. Wherever possible, the same reference numbers will be used throughout the drawings to refer to the same or like parts. It is apparent that the described embodiments are some but not all of the embodiments of the present invention. Based on the disclosed embodiment, persons of ordinary skill in the art may derive other embodiments consistent with the present disclosure, all of which are within the scope of the present invention.

The disclosed method for target tracking may be used to track different targets, e.g., human faces, feet, and gestures. Specifically, using tracking gestures as an example, the method for target tracking may be integrated into a dynamic gesture recognition system to implement corresponding control operations through tracking and recognizing a user's gestures. For example, the disclosed method may be used in appliance control to control various appliances. A user may use gestures to control the on and off states of a TV, change channels and volume of a TV, change temperatures and wind directions of an AC, or control action options and cook time of an induction cooktop, etc. The disclosed method may also be used to operate as a mouse, i.e., use gesture to operate a computer instead of a mouse. The disclosed method may also be used for handwriting in the air, i.e., performing handwriting recognition for the user's handwriting in the air to understand the user's intentions.

The tracking of the user's gesture is used as an example to illustrate the present disclosure. The subject to execute the disclosed embodiments may be a device for target tracking. The device may be a separate/independent single-target-gesture tracking system, or a device integrated in a single-target-gesture tracking system. The device the target tracking may be implemented through software and/or hardware.

In conventional technology, during the tracking of a target gesture by a conventional single-target-gesture tracking system, tracking loss and/or tracking drift due to interference by a target similar to a human's hand occur when the hand gesture changes. The disclosed method for target tracking may solve the abovementioned problems. That is, the disclosed method may overcome technical problems of a conventional single-target-gesture tracking system such as low efficiency and low robustness during a tracking process.

The technical solution of the present disclosure is now illustrated in detail in connection of the embodiments. The embodiments described in the present disclosure can be combined when possible. Same or similar concepts and/or elements may be used in different embodiments.

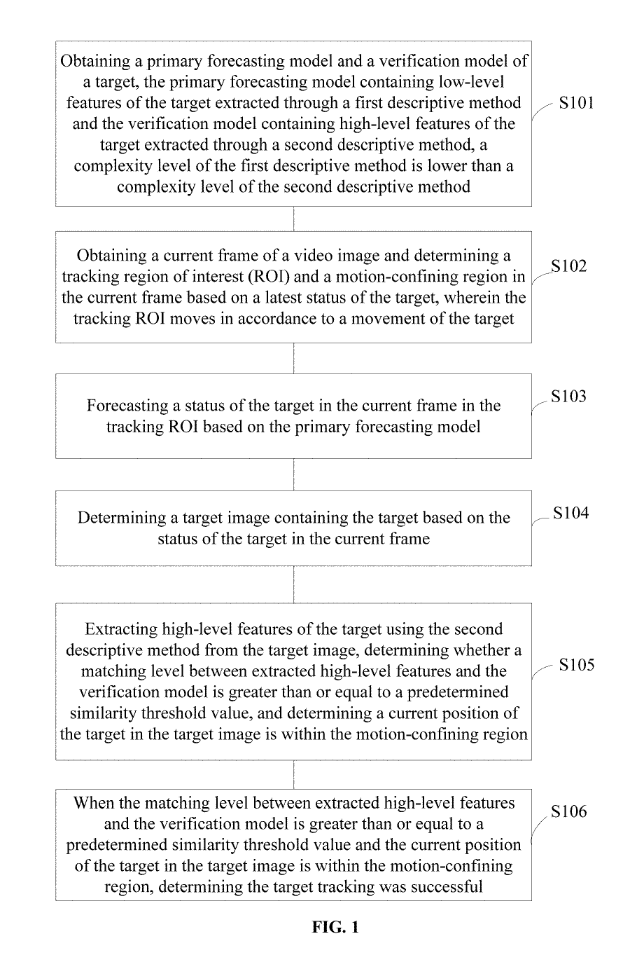

FIG. 1 illustrates an exemplary process of the disclosed method for target tracking. In the present disclosure, the status of a target being tracked, in the current frame, may be forecasted based on a primary forecasting model. A verification model may verify the forecasted status of the target being tracked to determine whether the tracking was successful. As shown in FIG. 1, the process may include steps S101-S106.

In various embodiments of the present disclosure, a target may be the target of interest, for example, in a tracking process, a target may be the target being tracked; before a tracking process, a target may be the target to be tracked, and after a tracking process, a target may be the target tracked. The disclosed device for target tracking may be a single-tracking system used to track any suitable objects/targets. The tracking of gestures is merely used for illustrative purposes and is not meant to limit the scope of the present disclosure. In embodiments describing the tracking of gestures, a single-target tracking system may be a single-target-gesture tracking system. In various other embodiments describing tracking of other objects/targets, the single-target tracking system may also be a single-target-face tracking system, and so on.

In step S101, the model of the target may be obtained. The model of the target may include a primary forecasting model and a verification model. The primary forecasting model may apply a first descriptive method to extract the low-level features of the target. The verification model may apply a second descriptive method to extract the high-level features of the target. The complexity level of the first descriptive method may be smaller than the complexity level of the second descriptive method.

Specifically, when not in the process of a tracking operation, e.g., when starting or after completing a tracking task, the disclosed single-target tracking system may start gesture detection to obtain the model of the target to be tracked in the next tracking operation. That is, the low-level features of the target and the high-level features may be obtained prior to a tracking process. For example, the target may be a gesture and the single-target tracking system may be a single-target-gesture tracking system. The model of the target to be tracked, recording the feature of the target to be tracked, may be the basis for target tracking. The primary forecasting model may apply a first descriptive method to extract the low-level features of the target. The verification model may apply a second descriptive method to extract the high-level features of the target. The complexity level of the first descriptive method may be smaller than the complexity level of the second descriptive method.

In both the primary forecasting model and the verification model, the information contained in the two models may include the attribute and/or feature description of the target. The attribute and/or feature characteristic data may be used as the standards for similarity measurement during tracking and as the benchmark when verifying the forecasted results. The primary forecasting model may forecast the status of the target in the current frame. The forecasted status may include the location information, the size (scaling information), the deformation information, and the direction information, of the target. The verification model may mainly be used to verify whether the forecasted status of the target, in the current frame, is accurate.

A plurality of descriptive methods of a target image may be used in gesture tracking. Common descriptive methods of a target image may include: (a) description based on geometric features, e.g., regional characteristics, contours, curvatures, and concavities; (b) description based on histograms, e.g., color histograms, texture histograms, and gradient-direction histograms; (c) description based on skin color membership degree of images; and (d) description based on pixel/super pixel contrast, e.g., point pair features, and Haar/Haar-like features. Generally, the descriptive method used for verification may be different from the descriptive method used for forecasting. That is, the descriptive method for high-level features in a verification model may be different from the descriptive method for low-level features in a primary forecasting model. First descriptive methods for the low-level features in a primary forecasting model may be defined to form a set of Ωp, and second descriptive methods for the high-level features in a verification model may be defined to form a set Ωv. The complexity level of a first descriptive methods in set Ωp may be smaller than the complexity level of a second descriptive methods in set Ωy.

In some embodiments, the first descriptive methods in set Ωp may include, e.g., a descriptive method for binary mask blocks, a descriptive method for binary mask histograms, a descriptive method for probabilistic graph obtained from skin color detection, and a descriptive method for color histograms. In some embodiments, the second descriptive methods in set Ωv may include, e.g., a descriptive method for local binary pattern (LBP) histograms and a descriptive method for camshift. The complexity level of a first descriptive method in set Ωp may be smaller than the complexity level of a second descriptive method in set Ωy. Thus, it can be ensured the forecasting, of the status of the target in the current frame, is fast and of high efficiency.

The specific process to obtain the model of a target may be a process of tracking initialization. For example, the target may be a gesture, and the tracking initialization may be implemented through gesture detection. When the target (a predetermined gesture) is detected, features of the target may be extracted from the video and the attribute and/or features of the target may be described to obtain the model of the target. A first descriptive method and a second descriptive method may be used to extract the features of the target respectively. That is, the primary forecasting model and the verification model may be obtained, to be used for the base of matching forecasting and forecasting verification in the subsequent tracking phase.

The gesture detection in the tracking phase may be performed in the entire image or only in a portion of the image. In some embodiments, detection may be performed in a special region of a video image to realize initialization. For example, the special region may be determined to be substantially in the center of the video image and may occupy about a quarter of the video image. In some embodiments, arranging a special region may have the following advantages to the single-target tracking system.

First, arranging a special region at a desired portion of a video image may be consistent with the operating habit of the user. When operating the single-target tracking system, a user often raises his/her hand to a comfortable position P before making a gesture. Accordingly, the user may consider the starting position of the tracking to be P, instead of any other positions when the hand was raising. Thus, performing the detection in the special region may facilitate accurate initialization and may make it easier for the subsequent dynamic gesture recognition.

Further, the robustness of the detection may be enhanced and false detection may be reduced. Accordingly, search area, i.e., area determine to be searched to locate the target, can be reduced, and interferences from complex background and dynamic background can be effectively reduced. It may be easier for the user to operate, and the interferences from the non-operating individuals can be reduced. Interferences from the gestures resulted from unconscious behaviors and non-operating gestures can be reduced.

Further, the quality of subsequent tracking process may be enhanced. If, during the tracking initialization, it is found that the gesture in the image is blurry, as a result of rapid movement of the hand when raising, the accuracy of the initialized model of the target may be reduced. The quality of the subsequent tracking process may be affected. Detecting a gesture in the special region may effectively suppress the inaccuracy of the initialization of the model due to rapid movement of the hand.

Further, arranging a special region may reduce the search area and increase detection efficiency.

In the tracking initialization phase, the single-target tracking system may detect a plurality of predetermined gestures, or detect a single particular gesture. In one embodiment, the single-target tracking system may detect a closed palm. False detection may be reduced and detection efficiency may be greatly increased.

The detection method used in the tracking initialization phase may incorporate a combination of various information, e.g., operation information, skin color information, and texture of the hand. Commonly-used rapid detection methods, incorporating various information of the target for the detection, may include the follows.

First, the geometric information of the target, e.g., the predetermined gesture, may be used for gesture detection and/or gesture recognition. For example, a background subtraction method and/or a skin color segmentation method may be used to separate the gesture region, and the shape of the separated region may be analyzed for gesture recognition.

Further, the appearance information of the target, e.g., the predetermined gesture, may be used for gesture detection and/or gesture recognition. For example, the appearance information may include, e.g., texture and local brightness statistics. The methods applying the appearance information of the target may include, e.g., haar feature with adaboost detection method, point pair feature with random tree detection method, and LBP histogram feature with support vector machine detection method.

In step S102, the current frame of the video image may be obtained; and based on the latest status of the target, the tracking ROI and the motion-confining region in the current frame may be determined. The tracking ROI may move according to the movement of the target.

Specifically, after obtaining the model of the target, the single-target-tracking system may obtain the current frame of the video image through the camera. The single-target-tracking system may, based on the latest status of the target, determine the tracking ROI and the motion-confining region of the target. The latest status of the target may be the most recently updated status of the target. In some embodiments, the latest status of the target may be the status of the target in the previous frame of the video image. In some other embodiments, the latest status of the target may also be the status of the target in a frame a plurality of frames before the current frame. For example, when the time corresponds to the current fame of the video image is t5, the time corresponds to the previous frame of the video image is t4, the time corresponds to the frame two frames prior to the current frame is t3, the time corresponds to the frame three frames prior to the current frame is t2, the latest status of the target may be the status of the target in the frame corresponding to t4.

In some other embodiments, the latest status of the target may be the status of the target in the frame corresponding to t2. In this case, the target tracking in the previous frame and in the frame two frames prior to the current frame may have failed or been unsuccessful, and the status of the target may be the status in the frame three frames prior to the current frame.

The abovementioned motion-confining region may be a confining region determined based on the initially-detected status of the gesture when the model of the target was being initialized. The initially-detected status of the gesture may include the position information, the size information, and the inclination angle, of the gesture. The reasons for choosing such as motion-confining region may be that, the initial position of the gesture is often the most comfortable position when the user raises his/her hand. Limited by the link between the joints of the body or personal habit, a human's hand moves easily near this position. If the user's hand is too far away from the motion-confining region, the user may feel tired, which may cause the gesture to be largely changed or deformed to result tracking failure. The motion-confining region may be kept unchanged during the tracking process.

The tracking ROI may be determined based on, e.g., the continuity characteristics of the motion of the target, and the status of the target in the previous frame or frames prior to the previous frame. The single-target tracking system may forecast the region the target may potentially appear, and may only search the best matching model of the target in this region. That is, the single-target tracking system may search for the target in the region. The tracking ROI may move according to the movements of the target. For example, the tracking ROI of the current frame may be located substantially at the center of the image. In the next frame, because of the movement of the user's hand, the tracking ROI may be located at another position. However, the motion-confining region in the present frame and in the next frame may be located at the same position. In fact, the position of the target may normally be within the tracking ROI. Based on the disclosed method, the search area may be greatly reduced and the tracking efficiency may be improved. Unnecessary matching at irrelevant positions may be avoided, and tracking drift and erroneous matching may be reduced during the tracking process. In addition, the confinement of the tracking ROI may also be a potential reminder to the user not to move the gesture too fast. Blurry imaged caused by rapid movement, which further results impaired tracking efficiency, may be reduced. Erroneous matching in skin areas, e.g., face, neck, and arm, during tracking, may be effectively reduced.

In step S103, in the tracking ROI, the single-target tracking system may forecast the status of the target in the current frame based on the primary forecasting model.

Specifically, in the tracking ROI, after the single-target-tracking system obtains the tracking ROI and the motion-confining region in the current frame, the single-target-tracking system may, based on the latest status of the target, forecast the status of the target in the current frame. The forecasted status may include the position information, the size information (scaling information), the deformation information, and the direction information, of the target. Some practical fast tracking and forecasting methods are discussed below as examples.

Color histograms may be used to express the distribution of the pixel values of the target. Back propagation image P may be calculated based on the color histograms. Camshift algorithm tracking may be performed based on P.

Further, the color membership degree graph P may be calculated based on skin color models. The pixel value at a point in P may represent the probability the point being a skin color point. Camshift algorithm tracking may be performed based on P.

Further, the source image/blocks, LBP histograms/blocks, gradient-direction histograms, Haar features, and so on may be used as image description, to be combined with particle filter method for tracking.

Further, randomly-selected points from the image, mesh points formed by uniform subdivision, detected Harris corner points, and feature points of scale-invariant feature transform/speeded up robust features, may be used for tracking based on optical flow method, to analyze the tracking result comprehensively to further obtain the status of the target.

Basically, the tracking forecasting methods described above are to search for the best match of the primary forecasting model from the candidate status of the target contained in a certain region. The candidate status of the target refers to the many possible status values when the target is in different positions in the image and has different scaling information. That is, the status of the target has a plurality of values in the current frame. It can also be understood that a forecasting method generates a series of candidate status from the region and selects the best match S. The best match S may not necessarily be the actual status of the target, so the best match S needs to be verified. Steps S104 and S105 are described below for the verification process.

In step S104, based on the status of the target in the current frame, the target image containing the target may be determined.

In step S105, based on the second descriptive method, the single-target tracking system may extract high-level features of target from the target image, determine whether the matching degree between the extracted high-level features and the verification model is greater than or equal to a predetermined similarity threshold value, and determine whether the current position of the target in the target image is within the motion-confining region.

Specifically, after forecasting the status of the target in the current frame, the single-target-tracking system may, based on the status of the target in the current frame, determine the target image containing the target. The target image may be a color image in the current frame. Because the forecasted status of the target in the current frame may not be accurate, the verification model is used to verify the status of the forecasted status. That is, based on the second descriptive method, for verification, in the verification model, high-level features of the target may be extracted from the target image corresponding to status S, and may be compared with the high-level features in the verification model, to determine the similarity level between the extracted high-level features, from the target image, and the high-level features in the verification model, is greater than a predetermined similarity threshold value. The single-target tracking system may also determine whether the target, contained in the target image, is currently located within the motion-confining region.

In step S106, if the similarity level between the extracted high-level features of the target and the verification model is greater than the predetermined similarity threshold value, and the current position of the target, in the target image, is within the motion-confining region, the single-target tracking system may determine the tracking of the target was successful.

Specifically, if the similarity level between the extracted high-level features of the target and the verification model is greater than or equal to the predetermined similarity threshold value, and the current location of the target, contained in the target image, is within the motion-confining region, it may be determined that the tracking was successful. Otherwise, it may be determined that the tracking failed or was invalid. The reasons causing the tracking to fail or to be invalid may be as follows.

First, the matching level between the high-level features of the target, extracted from the target image according to the second descriptive method in Ωv, and the verification model, is smaller than the predetermined similarity threshold value. That is, the matching failed.

Further, the current position of the target in the target image may have moved out of the motion-confining region.

In some embodiments, the forecasting method corresponding to the primary forecasting model may be a color histogram with camshift algorithm. The second descriptive method used for forecasting verification in the verification model may include a block-based LBP texture histogram and a histogram of oriented gradients (HOG).

In the target tracking method provided by the disclosure, the tracking ROI and the motion-confining region of the target in the current frame of the video image may be determined, through obtaining the primary forecasting model and the verification model, based on the latest status of the target. Thus, in the tracking ROI, the latest status of the target and the status of the target in the current frame forecasted by the primary forecasting model, may be combined. The verification model and the motion-confining region may be used to verify the status of the target in the current frame, to ensure the accuracy of the tracking process. Because the first descriptive method in the primary forecasting model is relatively simple, the efficiency of the tracking forecasting may be improved. Accordingly, the tracking efficiency may be improved.

Further, because the complexity level of a second descriptive method in the verification model is higher than the complexity level of a first descriptive method, the second descriptive method may describe the features of the target in the target image with more details, the effectiveness of the forecasting verification may be ensured. The tracking result may have improved robustness. Further, because of the arrangement of the tracking ROI and the motion-confining region, the search area may be greatly reduced, and the tracking process may be more efficient. Unnecessary matching at irrelevant positions may be avoided. Accordingly, tracking drift and erroneous matching during the tracking process may be easier to suppress.

FIG. 2 illustrates another exemplary method for target tracking provided by the present disclosure. In one embodiment, local detection may be performed in the tracking ROI in the current frame, to determine whether models of the target, being currently tracked, need to be updated. Based on the embodiment illustrated in FIG. 1, the embodiment illustrated in FIG. 2 may further include steps S201 and S202.

In step S201, the single-target tracking system may determine, whether other predefined targets other than the target exist in the tracking ROI, to obtain a detection result.

Specifically, the tracking of a gesture may be used to illustrate the present embodiment. In gesture recognition, the user's hand may be tracked to obtain the trajectory of the user's hand, and the gesture of the user's hand in each frame, i.e., static gesture, may be recognized. In many systems, the recognition of the status gesture during a tracking process are obtained through recognizing the target image corresponding to the forecasted status S. Two problems may exist in such systems. First, when drifting gradually occurs in the tracking process, the target image corresponding to the forecasted status S may not actually match the gesture region. For example, the gesture region may be the user's hand, extending from the arm, and a part of the gesture. At this time, the recognition performed on the gesture region may lead to inaccurate recognition result. Further, even for accurate tracking, only performing a one-time recognition on the target image corresponding to the forecasted status S may result relatively high recognition error.

Thus, in the embodiments of the present disclosure, a multi-scale sliding window detection scheme may be used to detect predefined gestures other than the tracked gesture (i.e., the target) in the tracking ROI. The window scale may be set according to the current status of the target in the current frame. The target window detected for each type of gesture may be clustered to obtain a plurality of clusters. A gesture having the highest confidence may be selected from the target windows corresponding to the gestures. The position and type of the gesture corresponding to the target window in the current frame of video image may be calculated. The detection result may include that other predefined gestures exist within the tracking ROI. The detection result may also include the positions and types of the other predefined gestures in the current frame of the video image. If no target window is detected by any type of gestures (i.e., no predefined gesture other than the tracked gesture is detected in the tracking ROI region), or the clusters do not meet the preset requirements, the detection result may be that no other predefined gestures exist within the tracking ROI.

In step S202, the single-target tracking system may determine whether the model of the target needs to be reinitialized based on the detection result.

Specifically, as an example, a gesture may be the target. If the detection result determines other predefined gestures exist in the tracking ROI, the detection result may include the positions and types of gestures of the other predefined gestures in the current frame of the video image. It may be determined that the posture of the gesture has changed during the tracking process. That is, the gesture has undergone deformation during the tracking process. Accordingly, the single-target-tracking system may reinitialize the model of the target based on the detected predefined gestures.

If the detection result determines no other predefined gestures exist in the tracking ROI, and the tracking of the gesture fails in the tracking of the gesture in the current frame, the model of the target may not be updated. That is, the classification result of the gesture postures in the current frame may be recorded as the gesture postures recorded in the model of the target.

If the detection result determines no other predefined gestures exist in the tracking ROI, and the tracking of the gesture is successful in the current frame, the parameters in the model of the target may be corrected. In the present disclosure, correction of parameters is different from the abovementioned reinitialization. For example, the positions and sizes of gesture may be corrected. To enable the model of the target to adapt to the gradual change of the target during a movement, the model of the target may need to be updated incrementally, i.e., incrementally correcting of parameter. The updates of the algorithms may be based on the features used in the model of the target, the forecasting method, and the verification method. Some descriptive methods and related update methods are described below.

For example, if the model of the target is based on the descriptive method of color histogram with camshift algorithm, the color histogram may be updated using H(i)=aH(i)+(1−a)Hₜ(i) when the parameter correction (progressive updates) of the target is being performed, where H(i) represents the i^{th} element of the color histogram and Hₜ represents color histogram of the target image corresponding to the current forecasted status S.

If the model of the target is based on the descriptive method of size-normalization-based source image with particle filer algorithm, and the sub-space formed by all the images of the target appearance may be represented by the model. When performing the parameter correction (progressive updates) of the target, a particle weight may be calculated by calculating the distance between the particle and the sub-space. A certain number of positive samples may be accumulated every certain video frames. The sub-space may be updated through incremental principal component analysis (PCA) decomposition.

If the model of the target is based on the feature points of the image (Harris, Affinr Harris, SIFT, SURF, etc.) with particle filter algorithm, a codebook or a dictionary made up of the feature points may represent the model, and the matching degree between the feature points of the particle image and the codebook/dictionary may be used as the weight of the particle. When the parameter correction (progressive updates) of the target is performed, the codebook or the dictionary may be updated according to the features of the target image of the current status.

In the abovementioned embodiment, the detection result of sliding windows is used for classification to improve the accuracy of classification. The use of sliding windows is based on that this process generates a large number of windows that contains gestures being tracked, and the confidence of multiple classification can be higher than the confidence of a single classification. This method can improve the accuracy of classification of static gestures in tracking. The method may also solve the problem of tracking failure, resulted from the model of the target not having enough time for learning due to sudden movement of hand gestures. Often, when the gesture changes from one to another, drift occurs between the two gestures, which leads to erroneous tracking. The disclosed method may be less susceptible to false positive rate.

The disclosed method for target tracking may improve the efficiency and robustness of tracking forecasting. Further, the arrangement of the tracking ROI and motion-confining region may greatly reduce the search area and improve the efficiency of tracking. Unnecessary matching at irrelevant positions may be avoided, and tracking drift and the erroneous matching during the tracking process can be reduced. Meanwhile, by detecting whether predefined targets other than the target exist in the tracking ROI in the current frame of the video frame, a detection result may be obtained. By combining the detection result and the tracking result (successful tracking or unsuccessful tracking), it can be ensured that the model of the target can be reinitialized timely. The disclosed method may solve the problem of tracking failure, resulted from the model of the target not having enough time for learning due to sudden movement of hand gestures. Further, the use of multi-scale sliding window detection may improve the recognition of static gestures during a tracking process.

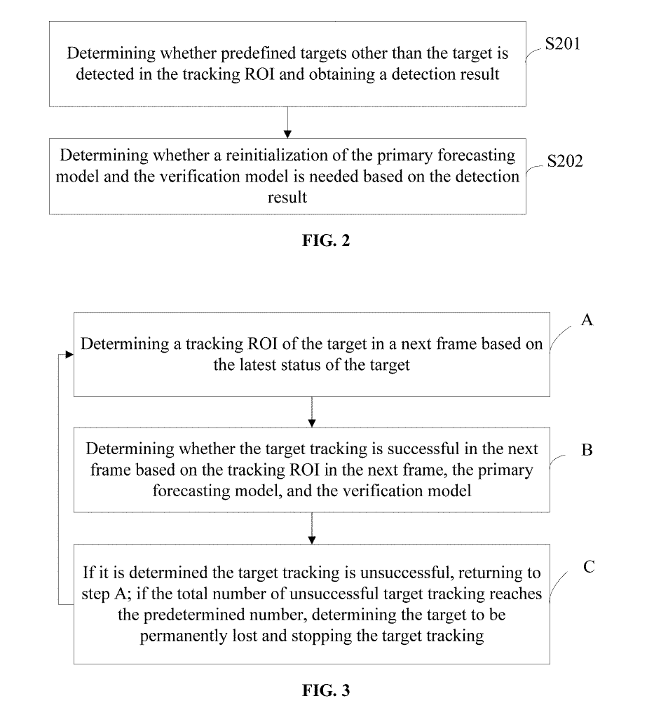

FIG. 3 illustrates another exemplary process for target tracking. In one embodiment, the matching degree between the high-level features, extracted from the target image, and the verification model may be greater than or equal to the predetermined similarity threshold value. Also, when the current positon of the target in the target image is not located within the motion-confining region, the single-target-tracking system may determine whether the target is permanently lost or temporarily lost, to further determine the specific process of the actual tracking failure. Based on the abovementioned embodiments, the disclosed method may further include steps A-C.

In step A, based on the latest status of the target, the tracking ROI of the target in the next frame may be determined.

Specifically, when the matching degree between the high-level features, extracted from the target image, and the verification model may be greater than or equal to the predetermined similarity threshold value, and the current positon of the target in the target image is not located within the motion-confining region, it may be determined the tracking of the target failed or was unsuccessful. Accordingly, the single-target-tracking system may, based on the latest status of the target, determine the tracking ROI of the target in the next frame. The description of the latest status may be referred to the embodiment illustrated in FIG. 1.

In step B, based on the tracking ROI of the target in the next frame, the motion-confining region, the primary forecasting model, and the verification model, whether the tracking of the target is successful in the next frame, can be determined.

Specifically, when determining the target is located within the tracking ROI, i.e., represented by region “a”, the single-target tracking system may forecast the status of the target in the next frame by applying the primary forecasting model, and determine the target image, i.e., represented by image “P”, corresponding to the status of the target in the next frame. Further, high-level features of the target may be extracted from the target image to determine whether the matching degree between the high-level features and the verification model is greater than or equal to the similarity threshold value, and determine whether the positon of the target in the target image is within the motion-confining region (the location of the motion-confining region may be fixed), to further determine whether the tracking of the target in the next frame can be successful. The specific operation of step B may be referred to steps S102-S106 illustrated in FIG. 1, in which the “current frame” can be replaced by the “next frame” to illustrate step B.

In step C, if the tracking was unsuccessful, the process may proceed to step A; and if the number of unsuccessful tracking has reached a predetermined number, the single-target tracking system may determine the target to be permanently lost and the tracking may be ended.

Specifically, when it is determined the tracking of the target was unsuccessful in the next frame, the single-target-tracking system may, again, based on the latest status of the target, determine the tracking ROI of the target in the next frame. The single-target tracking system may further, based on the tracking ROI, the motion-confining region, the primary forecasting model, and the verification model, of the target in the frame after the next frame, determine whether the tracking of the target in the frame after the next frame may succeed, and so on. If the number of unsuccessful tracking reaches a predetermined number, the single-target tracking system may determine the target to be permanently lost and the tracking may be ended. If the tracking succeeded before the number of unsuccessful tracking reaches the predetermined number, it may be determined that the target was temporarily lost.

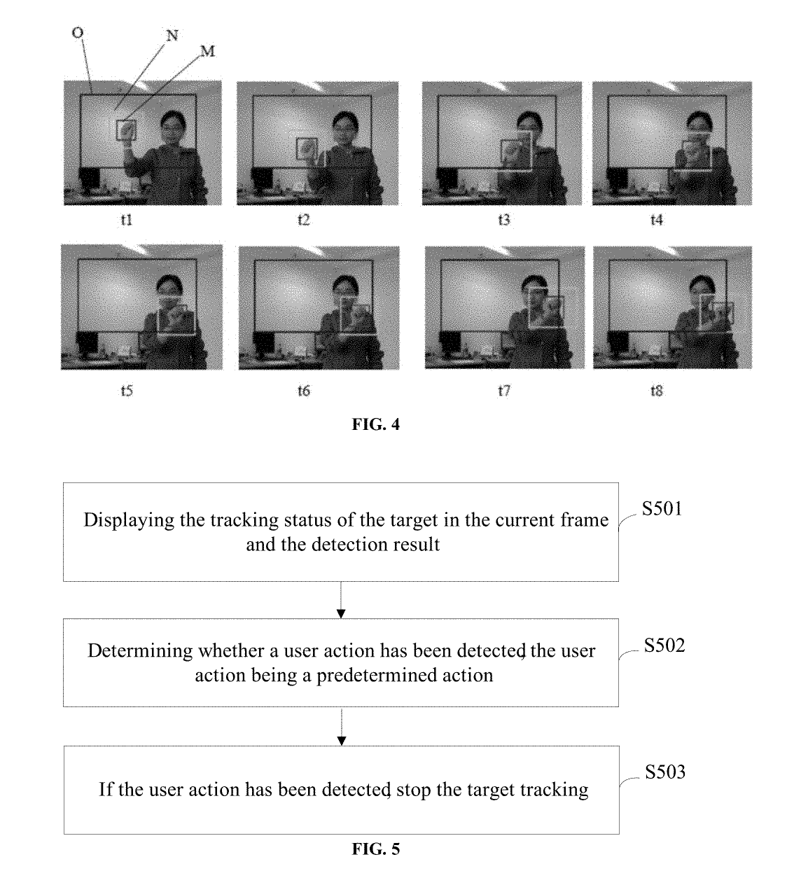

For example, a tracking ROI and a motion-confining region are shown in FIG. 4. The area defined by rectangular box M represents the gesture region of the tracked gesture, the area defined by rectangular box N represents the tracking ROI, and the area defined by rectangular box 0 represents the motion-confining region defined by the initial position of the gesture.

As shown in FIG. 4, at time t1, a “fist” gesture may be detected, and times t2-t8 are a plurality of selected frames representing sequential movement of the target from the tracking process started from the detection of the “first” gesture. The motion-confining region O may be determined based on the gesture detected at t1, and may be kept unchanged during the current tracking process. The tracking ROI N may be dynamically adjusted according to the movement of the gesture. As shown by the tracking status at t7 and t8, the tracking result may indicate the user's hand has moved out of the motion-confining region. At this time, the gesture being tracked may be determined to be temporarily lost. Based on the latest status, i.e., status of being successfully tracked, of the target, a new tracking ROI may be determined. Tracking may be continued to be performed in the new tracking ROI until the tracked gesture is detected in the new tracking ROI. That is, the tracking succeeded before the number of unsuccessful tracking reaches the predetermined number. Also, the tracking process may be stopped when the status of the target is determined to be permanently lost from being temporarily lost. That is, the number of unsuccessful tracking reaches the predetermined number.

According to the disclosed method for tracking target, after the target is lost, frame detection may still be performed near the region the target was lost. Problems such as interrupted tracking caused by a temporary loss of the target may be reduced. The robustness of the tracking process may be further improved.

FIG. 5 illustrates another exemplary process of target tracking provided by the present disclosure. In one embodiment, the tracking status of the target in the current frame and the abovementioned detection result may be displayed. After the observing the tracking status and the detection result, if the user determines the tracking was unsuccessful or was invalid, the single-target tracking system may be triggered to timely stop the tracking process. Based on the abovementioned embodiments, the disclosed method may further include steps S501-S503.

In step S501, the tracking status of the target in the current frame and the abovementioned detection result may be displayed.

Specifically, in one embodiment, as an example, the target may be a gesture. When the single-target tracking system determines the final tracking result of the target, regardless of a successful tracking or an unsuccessful tracking, the single-target tracking system may label the processing result, i.e., detection result and tracking status, of the target in each frame, in each frame of the video images, so that the user may observe the current processing result of the single-target tracking system. Accordingly, whether tracking drift and/or tracking lost have occurred may be presented intuitively to the user for observation. Especially, when the tracking drifts to a wrong background, the single-target tracking system may not be able to initiate a new gesture recognition process due to being in a tracking phase. However, once the error occurs, due to the reasons of online learning, it may be harder to correct. However, in the present disclosure, the tracking status of the target in the current frame and the detection result are displayed, and the user may observe the error. Thus, the user may determine whether actions need to be taken to end the tracking process.

In one embodiment, optionally, the single-target tracking system can be tested on an Android platform supported by hardware of a smart TV. The configuration of the hardware may be 700 MHz for the processor and 200 Mbytes for the single-target tracking system memory. An ordinary camera may be connected to the single-target tracking system through a USB port to capture video. If the tracking process starts, the tracking status of the target in the current frame and the test result can be displayed on the TV screen. The single-target tracking system can be less costly and requires only an ordinary camera in addition to the intelligent device that functions as a carrier. The tracking of the user's hand can be implemented without the need for additional wearable equipment.

In step S502, the single-target tracking system may determine whether a predetermined user's action is detected.

In step S503, if a predetermined user's action is determined, the tracking process may be ended.

Specifically, when the user observers that tracking drift and/or other tracking error have occurred in the present tracking process, the user may input a predetermined user's action into the tracking system. The single-tracking system may obtain the user's behavior through the camera. When it is determined the user's action is a predetermined user's action, the single-target tracking system may determine the current tracking process is experiencing problems and the tracking process may be stopped timely.

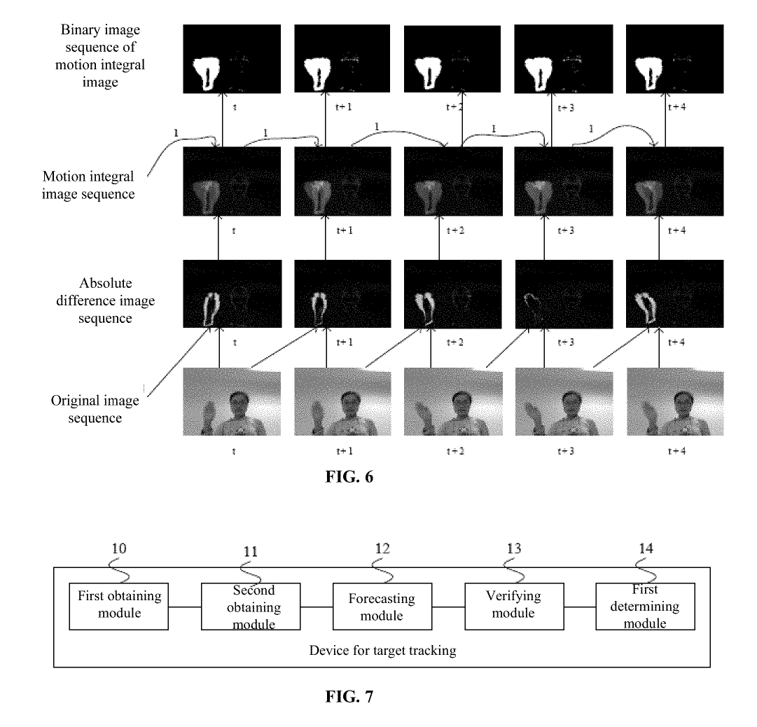

In some embodiments, the predetermined user's action may include a repeated waving operation. The repeated waving operation may refer to, using a point as the center, repeatedly moving the user's hand left and right and up and down. In a tracking process, the single-target tracking system may detect the waiving behavior in the movement-confining region in each frame. The detection of the movement may be through a motion integral image method. As shown in FIG. 6, the absolute difference image Dₜ may be calculated between any two consecutive frames, the motion integral image at time (t+1) may be calculated using equation Mₜ₊₁=(1−α)Mₜ+αDₜ, and the integrated image may be binarized, where a represents the update rate and a greater α represents a higher update rate. A connected component analysis may be performed on the mask image. If a large area of mask connected component exists in the motion-confining region, it may be considered abnormal. If more than half of a plurality of consecutive frames contains abnormal frames, the single-target tracking system may determine the waving behavior occurs, and the single-target tracking system may end the tracking process. In FIG. 6, the arrows pointing from left to right, i.e., the beginning of a detection to t4, indicate the time sequence of the user's action; the arrows pointing from bottom to top indicate the sequence of image processing; and the 45° arrows, pointing from the original image sequence to the absolute difference image sequence, indicate each absolute difference image is calculated between any two consecutive frames in the original image sequence. For example, at the bottom row, i.e., the original image sequence, the user starts to wave hand to the left (from t to (t+2)), and then starts to move back to the original position (from (t+2) to (t+4)). The frame taken at each time, from t to (t+4), is each processed sequentially using an absolute difference image method, a motion integral image method, and a binary image sequence method, to obtain the binary images in the first row of FIG. 6.

The abovementioned repeatedly waving hand may be used to stop various incorrect tracking processes. For example, the user may rapidly wave hand repeatedly in the tracking region, and the target may be blocked and thus be considered lost, and the tracking process may be ended. In another example, the user may rapidly wave hand repeatedly, the movement may cause the image to be blurry and have impaired quality, the tracking may fail and the tracking process may be ended. In another example, during the tracking process, the single-target tracking system may detect the waving behavior in the motion-confining region. Once the waving behavior is detected, the single-target tracking system may determine tracking error has occurred. Thus, the single-target tracking system may end the current tracking process.

According to the method for target tracking, the tracking status of the target and the detection result are visualized, such that the user may actively participate in the monitoring of the tracking process and actively correct errors. Thus, incorrect tracking can be stopped timely, and the fluency of the tracking may be enhanced.

It should be appreciated by those of ordinary skill in the art that all or part of the steps of implementing the above-described method embodiments may be accomplished by computer program and related hardware. The aforementioned program may be stored in a computer-readable storage medium. The program, when executed, performs the steps comprising the above-described method embodiments. The aforementioned storage medium includes various kinds of storage media capable of storing computer programs, such as a ROM, a RAM, a magnetic disk, or an optical disk.

FIG. 7 illustrates an exemplary device for target tracking. As shown in FIG. 7, the device may include a first obtaining module 10, a second obtaining module 11, a forecasting module 12, a verifying module 13, and a first determining module 14.

The first obtaining module 10 may obtain the models of the target. The models of the target may include a primary forecasting model and a verification model. The primary forecasting model may contain the low-level features of the target which are extracted through a first descriptive method. The verification model may include high-level features of the target which are extracted through a second descriptive method. The complexity level of the first descriptive method may be lower than the complexity level of the second descriptive method.

The second obtaining module 11 may obtain the current frame of video image, and determine the tracking ROI and the motion-confining region in the current frame based on the latest status of the target. The tracking ROI may move according to the movement of the target.

The forecasting module 12 may, within the tracking ROI, forecast the status of the target in the current frame based on the primary forecasting model.

The verifying module 13 may determine the target image containing the target based on the status of the target in the current frame. The verifying module 13 may, based on the high-level features of the target extracted from the target image through the second descriptive method, determine whether the matching level between the high-level features of the target and the verification model is greater than or equal to a predetermined similarity threshold value. The verifying module 13 may also determine whether the current position of the target in the target image is located within the motion-confining region.

The first determining module 14 may, when the verifying module 13 determines the matching level between the high-level features of the target and the verification model is greater than or equal to a predetermined similarity threshold value and the current position of the target in the target image is located in the motion-confining region, determine the tracking of the target was successful.

The disclosed device for target tracking, as shown in FIG. 7, may perform the embodiments illustrated in FIGS. 1-6. Details may be referred to previous description of FIGS. 1-6 and are not repeated herein.

Further, referring to FIG. 7, if the matching level between the high-level features of the target and the verification model is greater than or equal to a predetermined similarity threshold value and the current position of the target in the target image is not located within the motion-confining region, the second obtaining module 11 may determine the tracking ROI in the next frame based on the latest status of the target.

The first determining module 14 may, based on the tracking ROI, the motion-confining region, the primary forecasting model, and the verification model, of the target, determine whether the tracking of the target in the next frame is successful. When determining the tracking is unsuccessful, the first determining module 14 may, again, control the second obtaining module 11 to continue to determine the tracking ROI of the target based on the latest status of the target, until the number of unsuccessful tracking reaches a predetermined number. The first determining module 14 may then determine the target to be permanently lost and control the single-target tracking system to stop tracking.

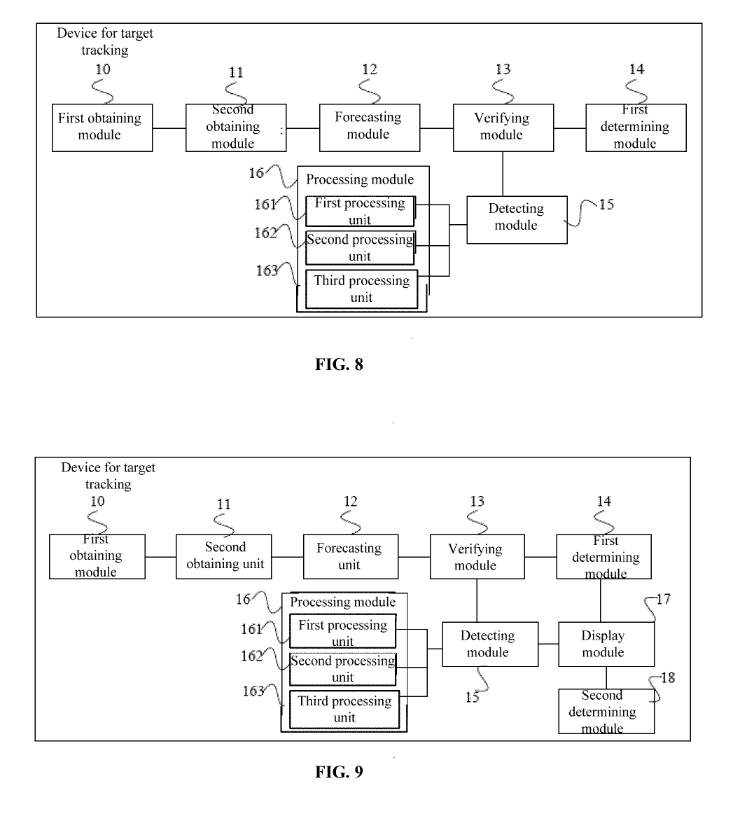

FIG. 8 illustrates another exemplary device for target tracking provided by the present disclosure. Based on the structure shown in FIG. 7, as shown in FIG. 8, the device may further include a detecting module 15 and a processing module 16.

The detecting module 15 may detect whether predefined targets other than the target exist in the tracking ROI and obtain a detection result.

The processing module 16 may determine whether the models of the target need to be reinitialized based on the detection result.

Further, as shown in FIG. 8, the processing module 16 may include a first processing unit 161, a second processing unit 162, and a third processing unit 163.

The first processing unit 161 may, when detection result indicates other predefined targets other than the target exist in the tracking ROI, reinitialize the models of the target based on the predefined targets.

The second processing unit 162 may, when detection result indicates no other predefined targets other than the target exist in the tracking ROI and the tracking of the target in the current frame fails, cancel the reinitialization of the models of the target.

The third processing unit 163 may, when detection result indicates no other predefined targets other than the target exist in the tracking ROI and the tracking of the target in the current frame was successful, perform parameter correction on the models of the target.

The disclosed device for target tracking, as shown in FIG. 8, may perform the embodiments illustrated in FIGS. 1-6. Details may be referred to previous description of FIGS. 1-6 and are not repeated herein.

FIG. 9 illustrates another exemplary device for target tracking provided by the present disclosure. Based on the structure shown in FIG. 8, as shown in FIG. 9, the disclosed device may further include a display module 17, to display the tracking status of the target in the current status and the detection result. Further, the device may further include a second determining module 18, to determine whether a user's action has been detected. The second determining module 18 may also end the tracking process when determining a user's action has been detected.

In some embodiments, the target may be a gesture.

The disclosed device for target tracking, as shown in FIG. 9, may perform the embodiments illustrated in FIGS. 1-6. Details may be referred to previous description of FIGS. 1-6 and are not repeated herein.

In some embodiments, the camera may move in accordance with the user when the user is moving. During the movement of the camera and the user, the camera may be configured to maintain the position of the motion-confining region, i.e., keep the position of the motion-confining region unchanged, in a frame of the video images so that the motion-confining region is relatively static with the frame. The tracking ROI may move with the target, e.g., a gesture. The disclosed device may detect and track the target according to the description of previous embodiments and are not repeated herein.

In certain embodiments, the camera may capture more than one targets in a frame of a video image. For example, the user may use both hands to signal and each hand may have same or different gestures. The disclosed device may respectively detect and track both gestures according to aforementioned embodiments. The two gestures may together indicate a signal or may each indicate a different signal. The camera may also capture more than two targets, e.g., the gestures of more than two users′, and detect and track the targets. The detection and tracking of each target may be referred to the description of previous embodiments and are not repeated herein.

In the present disclosure, the functions of various units and modules may be implemented through suitable hardware and/or software, e.g., a suitable computer system. Each unit or module may receive, process, and execute commands from the disclosed device. The device for target tracking may include any appropriately configured computer system. The device may include a processor, a random access memory (RAM), a read-only memory (ROM), a storage, a display, an input/output interface, a database; and a communication interface. Other components may be added and certain devices may be removed without departing from the principles of the disclosed embodiments.

Processor may include any appropriate type of general purpose microprocessor, digital signal processor or microcontroller, and application specific integrated circuit (ASIC). Processor may execute sequences of computer program instructions to perform various processes associated with disclosed. Computer program instructions may be loaded into RAM for execution by processor from read-only memory, or from storage. Storage may include any appropriate type of mass storage provided to store any type of information that processor may need to perform the processes. For example, storage may include one or more hard disk devices, optical disk devices, flash disks, or other storage devices to provide storage space.

Display may provide information to a user or users of the driving chip. Display may include any appropriate type of computer display device or electronic device display (e.g., CRT or LCD based devices). Input/output interface may be provided for users to input information into the device or for the users to receive information from the device. For example, input/output interface may include any appropriate input device, such as a keyboard, a mouse, an electronic tablet, voice communication devices, touch screens, or any other optical or wireless input devices. Further, input/output interface may receive from and/or send to other external devices.

Further, database may include any type of commercial or customized database, and may also include analysis tools for analyzing the information in the databases. Communication interface may provide communication connections such that the device may be accessed remotely and/or communicate with other systems through computer networks or other communication networks via various communication protocols, such as transmission control protocol/internet protocol (TCP/IP), hyper text transfer protocol (HTTP), etc.

In one embodiment, the input/output interface may obtain images captured from a camera, and the processor may obtain the models of the target, e.g., a gesture, by extracting high-level features and low-level features of the target. The processor may store the models in the RAM. The processor may further obtain the video images, and determine the tracking ROI and the motion-confining region in the current frame. The tracking ROI and the motion-confining region may be stored in the RAM. Further, the processor may forecast the status of the target in the current frame based on the primary forecasting model. Parameters of the models may be stored in the ROM or in the database. After determining the target image containing the target, the processor may compare the high-level features with the verification model to determine whether the current position of the target is within the motion-confining region. In some embodiments, the status of the target may be shown on the display.

The embodiments disclosed herein are exemplary only. Other applications, advantages, alternations, corrections, or equivalents to the disclosed embodiments are obvious to those skilled in the art and are intended to be encompassed within the scope of the present disclosure.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, corrections, or equivalents to the technical solutions of the disclosed embodiments can be obvious to those skilled in the art and can be included in this disclosure.

The present disclosure provides a method and device for target tracking. According to the present disclosure, a primary forecasting model and a verification model of the target being tracked can be obtained. Based on the latest status of the target, the tracking ROI and the motion-confining region in the current frame of the video image containing the target may be determined. Further, in the tracking ROI, the latest status of the target and the forecasted status of the target in the current frame by the primary forecasting model may be combined, and the verification model and the motion-confining model may be used to verify the status of the target in the current frame, to further determine the accuracy of the tracking process. Because the first descriptive method of the primary forecasting model is relatively simple, the tracking forecasting may have an improved efficiency. Accordingly, the tracking process may have an improved efficiency. In addition, because the complexity level of the second descriptive method is higher than the complexity level of the first descriptive method, the description of the target in the target image may contain more details, and the effectiveness of the forecasting verification may be ensured. The tracking result may have improved robustness. Further, because of the arrangement of the tracking ROI and the motion-confining region, the search area may be greatly reduced and the tracking may have higher efficiency. Unnecessary matching at irrelevant positions may be avoided, and tracking drift and/or erroneous matching during the tracking process may be reduced.

### REFERENCE SIGN LIST

First obtaining module 10
Second obtaining module 11
Forecasting module 12
Verifying module 13
First determining module 14
Detecting module 15
Processing module 16
First processing unit 161
Second processing unit 162
Third processing unit 163
Display module 17
Second determining module 18

What is claimed is:

1. A method for target tracking, comprising:
obtaining a primary forecasting model and a verification model of a target, the primary forecasting model containing low-level features of the target and the verification model containing high-level features of the target;
obtaining a current frame of a video image and determining a tracking region of interest (ROI) and a motion-confining region in the current frame based on a latest status of the target, wherein the tracking ROI moves in accordance to a movement of the target;
forecasting a status of the target in the current frame in the tracking ROI based on the primary forecasting model;
determining a target image containing the target based on the status of the target in the current frame;
extracting high-level features of the target from the target image, determining whether a matching level between extracted high-level features and the verification model is greater than or equal to a predetermined similarity threshold value, and determining a current position of the target in the target image is within the motion-confining region; and
when the matching level between extracted high-level features and the verification model is greater than or equal to a predetermined similarity threshold value and the current position of the target in the target image is within the motion-confining region, determining the target tracking is successful.

2. The method according to claim 1, further comprising:
determining whether predefined targets other than the target is detected in the tracking ROI and obtaining a detection result; and
determining whether a reinitialization of the primary forecasting model and the verification model is needed based on the detection result.

3. The method according to claim 1, wherein:
obtaining a primary forecasting model and a verification model of a target includes: applying a first descriptive method to extract the low-level features of the target and applying a second descriptive method to extract the high-level features of the target; and
extracting high-level features of the target from the target image includes applying the second descriptive method to extract the high-level features of the target, wherein
a complexity level of the first descriptive method is lower than a complexity level of the second descriptive method.

4. The method according to claim 2, wherein determining whether a reinitialization of the primary forecasting model and the verification model is needed based on the detection result includes:
when the detection result indicates predefined targets other than the target exist in the tracking ROI, reinitializing the primary forecasting model and the verification model based on the predefined targets; and
when the detection result indicates no predefined targets other than the target exists in the tracking ROI and the target tracking in the current frame was successful, performing parameter correction on the primary forecasting model and the verification model.

5. The method according to claim 4, further comprising displaying a tracking status of the target in the current frame and the detection result.

6. The method according to claim 5, further comprising:
determining whether a user action has been detected, the user action being a predetermined action; and
when the user action has been detected, terminating the target tracking.

7. The method according to claim 1, when the matching level between extracted high-level features and the verification model is greater than or equal to a predetermined similarity threshold value, and the current position of the target in the target image is outside the motion-confining region, further comprising:
step A, determining a tracking ROI of the target in a next frame based on the latest status of the target;
step B, determining whether the target tracking is successful in the next frame based on the tracking ROI in the next frame, the primary forecasting model, and the verification model; and
step C, when it is determined the target tracking is unsuccessful, returning to step A.

8. The method according to claim 7, wherein:
when the target tracking succeeds before a total number of unsuccessful target tracking reaches a predetermined number, determining the target to be temporarily lost; and
when the total number of unsuccessful target tracking reaches the predetermined number, determining the target to be permanently lost and terminating the target tracking.

9. The method according to claim 1, wherein the target is a gesture.

10. A device for target tracking, comprising:
a first obtaining module for obtaining a primary forecasting model and a verification model of a target, the primary forecasting model containing low-level features of the target and the verification model containing high-level features of the target;
a second obtaining module for obtaining a current frame of a video image and determining a tracking region of interest (ROI) and a motion-confining region in the current frame based on a latest status of the target, wherein the tracking ROI moves in accordance to a movement of the target;
a forecasting module for forecasting a status of the target in the current frame in the tracking ROI based on the primary forecasting model;
a verifying module for determining a target image containing the target based on the status of the target in the current frame, extracting high-level features of the target from the target image, determining whether a matching level between extracted high-level features and the verification model is greater than or equal to a predetermined similarity threshold value, and determining a current position of the target in the target image is within the motion-confining region; and
a first determining module, when the matching level between extracted high-level features and the verification model is greater than or equal to a predetermined similarity threshold value and the current position of the target in the target image is within the motion-confining region, for determining the target tracking was successful.

11. The device according to claim 10, further comprising:
a detecting module for determining whether predefined targets other than the target is detected in the tracking ROI and obtaining a detection result; and
a processing module for determining whether a reinitialization of the primary forecasting model and the verification model is needed based on the detection result.

12. The device according to claim 10, wherein:
obtaining a primary forecasting model and a verification model of a target includes: applying a first descriptive method to extract the low-level features of the target and applying a second descriptive method to extract the high-level features of the target; and
extracting high-level features of the target from the target image includes applying the second descriptive method to extract the high-level features of the target, wherein
a complexity level of the first descriptive method is lower than a complexity level of the second descriptive method.

13. The device according to claim 11, wherein the processing module comprises:
a first processing unit, when the detection result indicates predefined targets other than the target exist in the tracking ROI, for reinitializing the primary forecasting model and the verification model based on the predefined targets;
a second processing unit, when the detection result indicates no predefined targets other than the target exists in the tracking ROI and the target tracking in the current frame was unsuccessful, for cancelling reinitializing the primary forecasting model and the verification model based on the predefined targets; and
a third processing unit, when the detection result indicates no predefined targets other than the target exists in the tracking ROI and the target tracking in the current frame was successful, for performing parameter correction on the primary forecasting model and the verification model.

14. The device according to claim 13, further comprising a display module for displaying a tracking status of the target in the current frame and the detection result.

15. The device according to claim 14, further comprising a second determining module for
determining whether a user action has been detected, the user action being a predetermined action; and
when the user action has been detected, stop the target tracking.

16. The device according to claim 10, wherein when the matching level between extracted high-level features and the verification model is greater than or equal to a predetermined similarity threshold value, and the current position of the target in the target image is outside the motion-confining region,
the second obtaining module determines a tracking ROI of the target in a next frame based on the latest status of the target; and
the first determining module determines whether the target tracking is successful in the next frame based on the tracking ROI in the next frame, the primary forecasting model, and the verification model, and when it is determined the target tracking is unsuccessful, and returns to determining a tracking ROI of the target in a next frame based on the latest status of the target to determine whether the target tracking is successful in the next frame.

17. The device according to claim 16, wherein the first determining module
determines the target to be temporarily lost when the target tracking succeeds before a total number of unsuccessful target tracking reaches a predetermined number; and
determines the target to be permanently lost and stopping the target tracking when the total number of unsuccessful target tracking reaches the predetermined number.

18. The device according to claim 10, wherein the target is a gesture.
